(19) United States
(12) Patent Application Publication
(10) Pub. No.: US 2020/0056350 A1
(43) Pub. Date: Feb. 20, 2020

(54) CONTROL DEVICE FOR HYDRAULIC MACHINE

(71) Applicant: Yanmar Co., Ltd., Osaka-shi, Osaka-fu (JP)

(72) Inventors: Takayuki SHIROUZU, Chikugo-shi (JP); Hiroshi MATSUYAMA, Chikugo-shi (JP)

(73) Assignee: Yanmar Co., Ltd., Osaka-shi, Osaka-fu (JP)

(21) Appl. No.: 16/486,646

(22) PCT Filed: Feb. 6, 2018
(86) PCT No.: PCT/JP2018/005576

§ 371 Date: Aug. 16, 2019

(30) Foreign Application Priority Data
Feb. 17, 2017 (JP) 2017-028468

(51) Int. Cl. E02F 9/22; F15B 11/028

(52) U.S. Cl. CPC E02F 9/2225; F15B 11/028; E02F 9/2296; E02F 9/2232

(57) ABSTRACT

A hydraulic machine, such as a revolving excavator work machine, including a travel-purpose hydraulic motor whose capacity is switchable, in which a work accuracy is obtained by avoiding that a hydraulic motor mainly used for work travel in a large-capacity setting state is affected by an increased traveling speed resulting from a small-capacity setting state of a hydraulic motor. A control device for the hydraulic machine, in driving each of a plurality of hydraulic actuators, corrects a target value for a ratio of a supply flow rate to a required flow rate for each hydraulic actuator in accordance with a change in the engine rotation number and further corrects the target value for the ratio of the supply flow rate to the required flow rate for each hydraulic actuator in accordance with switching of the capacity of the travel-purpose hydraulic motor included in the plurality of hydraulic actuators.

### TECHNICAL FIELD

The present invention relates to a control device used for a hydraulic oil supply system for supplying hydraulic oil to a hydraulic actuator that drives a hydraulic machine such as a revolving excavator work machine.

### BACKGROUND ART

Conventionally known is a hydraulic oil supply system for a hydraulic actuator that drives a hydraulic machine such as a revolving excavator work machine, the hydraulic oil supply system being configured to supply hydraulic oil ejected from a variable displacement type hydraulic pump to the hydraulic actuator via a direction control valve, as shown in Patent Literatures 1, 2 (PTLs 1, 2) for example.

In the systems disclosed in the PTLs, a control mechanism for controlling an ejection flow rate from the variable displacement type hydraulic pump is configured to adjust the ejection flow rate from the hydraulic pump such that a difference (hereinafter, simply referred to as “differential pressure”) between an ejection pressure of the hydraulic pump and a load pressure at the secondary side of the direction control valve (at the inlet port side of the hydraulic actuator) can be constant, by using a load sensing valve, and on the other hand, the area of opening of a meter-in throttle that narrows a flow channel in the direction control valve from the hydraulic pump to the hydraulic actuator is changed in accordance with the amount of operation on a manual operation tool of the direction control valve. Accordingly, a necessary amount of hydraulic oil corresponding to an operating speed of the actuator set by the manual operation tool is supplied from the direction control valve to the hydraulic actuator. Thus, a supply flow rate that is substantially equal to a required flow rate of the actuator can be achieved, so that an operation efficiency of the hydraulic oil supply system can be increased.

PTLs 1, 2 disclose a technique enabling adjustment of a target differential pressure set by the load sensing valve. More specifically, a controller applies an adjustable control pressure to the ejection pressure of the hydraulic pump, against the load pressure at the load sensing valve.

Meanwhile, as shown in PTL 2, the conventional revolving excavator work machine has a plurality of hydraulic actuators in which, for example, a pair of travel-purpose hydraulic motors for individually driving a pair of traveling devices such as a pair of left and right crawler type traveling devices are provided.

PTL 2 discloses a technique of reducing the ejection amount from the hydraulic pump by lowering the target differential pressure in the load sensing valve in a case where only the travel-purpose hydraulic motors among the hydraulic actuators are driven, that is, in a case where it is detected that such setting as to travel the vehicle is made. This can reduce a loss of the ejection amount from the hydraulic pump which may otherwise occur when the travel-purpose hydraulic motors, which require a low load pressure as compared to other work-purpose hydraulic actuators, are driven, so that an operation efficiency of the hydraulic actuator can be increased.

As shown in Patent Literature 3 (PTL 3), there is known a travel-purpose hydraulic motor including a movable swash plate serving as capacity varying means, the travel-purpose hydraulic motor being configured such that the movable swash plate is switchable between two positions, namely, a high-speed position with a small inclination angle and a low-speed position with a large inclination angle. Suppose the ejection flow rate from the hydraulic pump is constant, placing the movable swash plate at the high-speed position reduces the capacity of the hydraulic motor which is consequently driven and rotated at a high speed, and placing the movable swash plate at the low-speed position increases the capacity of the hydraulic motor which is consequently driven and rotated at a low speed.

In PTL 3 above, switching the position of the movable swash plate of the hydraulic pump is implemented by a manual operation on, for example, a lever disposed near a driver seat in the vehicle. For example, to cause the vehicle to travel on a road, the high-speed position can be employed, and to cause the vehicle to perform work while traveling at a low speed, the low-speed position can be employed, at the operator's discretion.

### CITATION LIST

### Patent Literature

PTL 1:

Japanese Patent Application Laid-Open No. H2(1990)-76904

PTL 2: Japanese Patent Application Laid-Open No. 2011-247301

PTL 3: Japanese Patent Application Laid-Open No. H10(1998)-338947

### SUMMARY OF INVENTION

### Technical Problem

For a hydraulic machine such as a revolving excavator work machine including a travel-purpose hydraulic motor capable of two-stage speed change as shown in PTL 3 above, it is often demanded that a traveling speed of a vehicle obtained in a state (hereinafter referred to as “high-speed setting state”) where a movable swash plate of the travel-purpose hydraulic motor is at the high-speed position (small-capacity set position) be further increased. Meanwhile, a traveling speed of the vehicle in a state (hereinafter referred to as “low-speed setting state”) where the movable swash plate of the travel-purpose hydraulic motor is at the low-speed position needs to be just as high as the conventional traveling speed, for the purpose of keeping a reliable work accuracy.

A conceivable way to increase the traveling speed of the vehicle in the high-speed setting state is increasing an engine rotation number. In this case, however, switching to the low-speed setting state with the engine rotation number maintained results in an increase in the traveling speed in the low-speed setting state, too. This does not match the above-mentioned demand that the traveling speed in the low-speed setting state be just as high as the conventional one.

In this regard, PTL 3 reduces the traveling speed in the low-speed setting state by reducing a maximum ejection flow rate from the variable displacement type hydraulic pump. This technique, however, simply decreases a maximum inclination angle of the hydraulic pump by a predetermined angle in response to switching of the travel-purpose hydraulic motor to a large-capacity set position. Combining this technique with a pump control system using a load sensing valve as shown in PTL 1 can adjust a flow rate from a hydraulic pump to a hydraulic actuator in accordance with a manual operation amount as long as it is within an operation amount range that is not affected by reduction in the maximum ejection flow rate; however, once the operation amount enters a range that corresponds to the reduction amount of the maximum ejection flow rate, even increasing the manual operation amount up to the maximum operation amount under such a condition cannot adjust the flow rate to the actuator because the flow rate is in saturation. As a result, considerable deterioration of the operability may occur.

Replacing the hydraulic motor with one having a configuration (speed ratio) different from that of the two-stage switch type capacity varying means such as the movable swash plate can respond to the above-mentioned demand, but such a change requires a mechanical design change, which is a disadvantage in view of standardization of parts or the like, and leads to a cost increase.

### Solution to Problem

To solve the problems described above, some aspects of the present invention adopt the following means.

A control device according to the present application is a control device for a hydraulic machine including a plurality of hydraulic actuators that are driven by oil ejected from a variable displacement type hydraulic pump driven by an engine, the control device being configured to: in driving each hydraulic actuator, control a flow rate of oil ejected from the hydraulic pump such that the flow rate satisfies a required flow rate for the hydraulic actuator; and correct a target value for a ratio of a supply flow rate to a required flow rate for each hydraulic actuator, in accordance with a change in an engine rotation number. The plurality of hydraulic actuators include a hydraulic motor for traveling of the hydraulic machine, the hydraulic motor being configured such that its capacity setting is switchable between at least two different capacity settings. The control device is configured to correct the target value for the ratio of the supply flow rate to the required flow rate for each hydraulic actuator, in accordance with not only a change in the engine rotation number but also switching of the capacity of the hydraulic motor.

In a first aspect of the control device, to the plurality of hydraulic actuators, oil ejected from the hydraulic pump is supplied through a meter-in throttle of a direction control valve that is individually provided to each of the hydraulic actuators; and the required flow rate for each actuator is defined by an opening degree of the meter-in throttle of the corresponding direction control valve. The control device sets the same target value that is common to all the actuators, for a differential pressure between an ejection pressure of oil ejected from the hydraulic pump and a load pressure of oil supplied to each hydraulic actuator.

The control device is configured to control a flow rate of oil ejected from the hydraulic pump so as to attain the target value for the differential pressure with respect to all the hydraulic actuators. By correction of the target value for the differential pressure, correction of the target value for the ratio in accordance with a change in the engine rotation number and correction of the target value for the ratio in accordance with switching of the capacity of the hydraulic motor are implemented.

In a second aspect of the control device, the control device generates a control pressure for changing the target value for the differential pressure, at a secondary pressure of an electromagnetic proportional valve. The control device stores a plurality of maps as a correlation map of a control output value in correlation with the engine rotation number, the control output value being a current value applied to the electromagnetic proportional valve. The plurality of maps include two or more maps each corresponding to each of the at least two capacity settings of the hydraulic motor.

In a third aspect of the control device, the two or more maps include a first map corresponding to a small-capacity setting of the hydraulic motor, and a second map corresponding to a large-capacity setting of the hydraulic motor. The control device is configured such that in the large-capacity setting of the hydraulic motor, only when it is confirmed that the hydraulic motor is actually in a driven state, oil ejected from the hydraulic pump is subjected to a flow rate control based on the second map, and otherwise oil ejected from the hydraulic pump is subjected to a flow rate control based on the first map.

### Advantageous Effects of Invention

The control device for the hydraulic machine having the above-described configurations makes it possible to change the ratio (speed ratio) between an output speed of the travel-purpose hydraulic motor in the large-capacity setting and an output speed thereof in the small-capacity setting. That is, assuming that an operation amount on the direction control valve for the hydraulic motor is kept constant at a constant engine speed, an output speed difference caused by switching of the capacity can be set to a value different from a value specified by specifications of this hydraulic motor.

Accordingly, for example, if a high-rotation engine is provided for the purpose of increasing an on-road traveling speed of the hydraulic machine; a high idling rotation number (a maximum engine rotation speed)is increased, and therefore in a case of the small-capacity setting of the travel-purpose hydraulic motor, the on-road traveling speed can be increased by high-speed engine rotation, whereas in a case of the large-capacity setting, an output speed of the hydraulic motor can be suppressed low so as to be kept at the conventional traveling speed which enables work to be easily performed without any influence of an increase in the high idling rotation number involved in the higher engine rotation.

Changing the speed ratio can be implemented by changing the set position of a movable swash plate of the hydraulic motor. In such a case, however, a design change is required in relation to a complicated mechanism for positioning the movable swash plate, which may lead to a cost increase. The control device according to the present application is just required to adopt correction of the target value for the differential pressure between the ejection pressure and the load pressure, at a time of switching the capacity of the travel-purpose hydraulic motor, as described in the first aspect. This correction is a configuration that is adopted in an existing load-sensing type pump control system. For example, it is just required that two or more maps each corresponding to each capacity setting of the hydraulic motor be stored, as described in the second aspect. Accordingly, the control device that can exert the above-described effects at low costs can be provided.

Since the correction of the target value for the differential pressure controls a flow rate of oil ejected from the hydraulic pump, correction of the target value for the ratio of the supply flow rate to the required flow rate is applied not only to the travel-purpose hydraulic motor but also to all the actuators. In this case, if the output speed of the travel-purpose hydraulic motor in a case of the large-capacity setting is suppressed low as mentioned above, the traveling speed can be suppressed low, but in addition, the driving speeds of the other actuators are also reduced in response to the travel-purpose hydraulic motor being switched to the large-capacity setting, which lowers the efficiency of work.

In this respect, as described in the third aspect, in the large-capacity setting of the hydraulic motor, the second map for the large-capacity setting is used only when it is confirmed that the hydraulic motor is actually in the driven state. This allows the other actuators to be driven at driving speeds corresponding to the small-capacity setting of the hydraulic motor, irrespective of switching of the capacity of the hydraulic motor. Thus, it is possible to perform work with an efficiency comparable to the efficiency in the small-capacity setting, while suppressing only the traveling speed low.

### BRIEF DESCRIPTION OF DRAWINGS

FIG. 1 A side view of an excavation work machine as an embodiment of a hydraulic machine.

FIG. 2 A hydraulic circuit diagram showing a pressure oil supply system for supplying pressure oil to a hydraulic actuator.

FIG. 3 A block diagram of a load-sensing type pump control system.

FIG. 4 A graph of a supply flow rate to the hydraulic actuator relative to an engine rotation number under a load-sensing type pump control with no control pressure applied.

FIG. 5 Maps and graphs concerning the load-sensing type pump control, in which

FIG. 5(a) is a map of a control output value, FIG. 5(b) is a graph of the control pressure, and FIG. 5(c) is a graph of a target differential pressure.

FIG. 6 A graph of the supply flow rate to the hydraulic actuator relative to the engine rotation number under the load-sensing type pump control with a control pressure applied.

FIG. 7 A graph of the supply flow rate to the hydraulic actuator relative to an operation amount under the load-sensing type pump control.

FIG. 8 Maps and graphs concerning the load-sensing type pump control in response to switching of a capacity of a traveling motor, in which FIG. 8(a) is a map of the control output value, FIG. 8(b) is a graph of the control pressure, and FIG. 8(c) is a graph of the target differential pressure.

FIG. 9 A graph of the supply flow rate to the hydraulic actuator relative to the engine rotation number under the load-sensing type pump control in response to switching of the capacity of the traveling motor.

FIG. 10 A graph of the supply flow rate to the hydraulic actuator relative to the operation amount under the load-sensing type pump control in response to the switching of the capacity of the traveling motor.

### DESCRIPTION OF EMBODIMENT

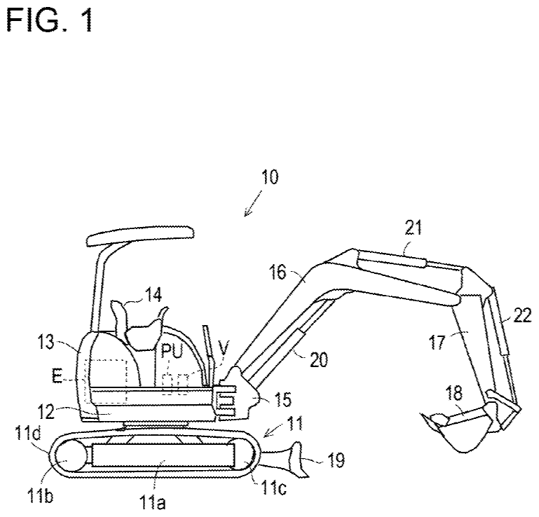

An overview configuration of a revolving excavator work machine 10 as an embodiment of a hydraulic machine shown in FIG. 1 will now be described. The revolving excavator work machine 10 includes a pair of left and right crawler type traveling devices 11. Each of the crawler type traveling devices 11 includes a truck frame 11a on which a driving sprocket 11b and a driven sprocket 11c are supported, with a crawler 11d wound on the driving sprocket 11b and the driven sprocket 11c so as to stretch therebetween. It may be conceivable that the traveling devices are wheel type traveling devices.

A revolving base 12 is mounted on the pair of left and right crawler type traveling devices 11 such that the revolving base 12 is rotatable about a vertical pivot relative to the both of the crawler type traveling devices 11. Mounted on the revolving base 12 is a hood 13 in which an engine E, a pump unit PU, a control valve unit V, and the like, are installed. Moreover, an operator's seat 14 is disposed on the revolving base 12. Manual operation tools such as levers and pedals for operating each hydraulic actuator (described later) are disposed on the front and lateral sides of the seat 14.

The revolving base 12 is provided with a boom bracket 15 that is rotatable in the horizontal direction relative to the revolving base 12. The boom bracket 15 pivotally supports a proximal end portion of a boom 16 such that the boom 16 can be rotated up and down. A distal end portion of the boom 16 pivotally supports a proximal end portion of the arm 17 such that the arm 17 can be rotated up and down. A distal end portion of the arm 17 pivotally supports a bucket 18 serving as a work machine such that the bucket 18 can be rotated up and down. As another work machine, an earth removing blade 19 is attached to the pair of left and right crawler type traveling devices 11 such that the earth removing blade 19 can be rotated up and down.

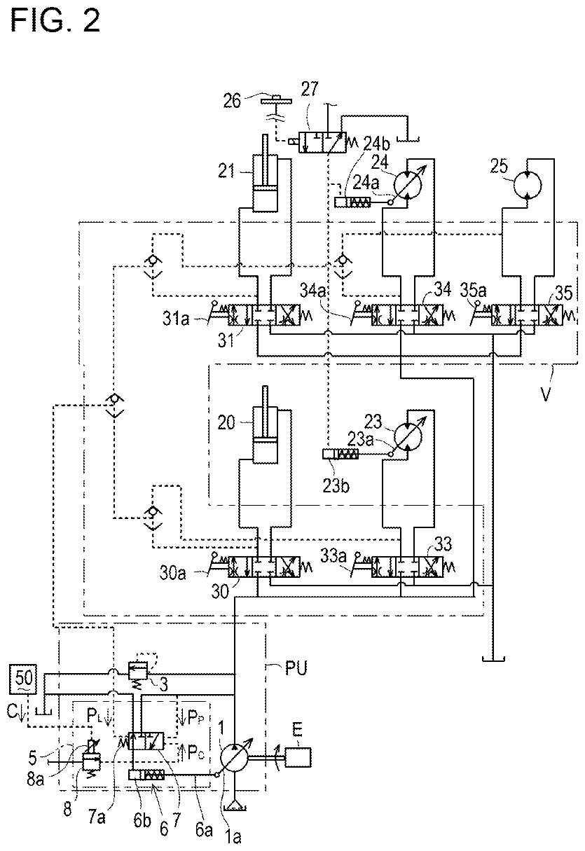

To drive the respective drive units of the revolving excavator work machine 10 mentioned above, the revolving excavator work machine 10 includes a plurality of hydraulic actuators as shown in FIG. 2. FIG. 1 shows typical hydraulic actuators, namely, a boom cylinder 20, an arm cylinder 21, and a bucket cylinder 22. Expansion and contraction of a piston rod of the boom cylinder 20 rotates the boom 16 up and down relative to the boom bracket 15. Expansion and contraction of a piston rod of the arm cylinder 21 rotates the arm 17 up and down relative to the boom 16. Expansion and contraction of a piston rod of the bucket cylinder 22 rotates the bucket 18 up and down relative to the arm 17.

In addition, the revolving excavator work machine 10 also includes expansion/contraction type hydraulic actuators constituted by hydraulic cylinders, such as a swing cylinder for horizontally turning the boom bracket 15 relative to the revolving base 12 and a blade cylinder for rotating the blade 19 up and down relative to the left and right crawler type traveling devices 11, though not shown in FIG. 1.

In addition, the revolving excavator work machine 10 also includes rotary type hydraulic actuators constituted by hydraulic motors, such as a first traveling motor 23 (see FIG. 2) for driving the driving sprocket 11b of one of the left and right crawler type traveling devices 11, a second traveling motor 24 (see FIG. 2) for driving the driving sprocket 11b of the other of the left and right crawler type traveling devices 11, and a revolving motor 25 (see FIG. 2) for revolving the revolving base 12 relative to the left and right crawler type traveling devices 11, though not shown in FIG. 1.

Referring to a hydraulic circuit diagram shown in FIG. 2, a description will be given to a supply control system for controlling a supply of oil ejected from a hydraulic pump to the respective hydraulic actuators included in the revolving excavator work machine 10. The revolving excavator work machine 10 includes a hydraulic pump 1 which is driven by the engine E. The hydraulic pump 1 supplies pressure oil to the boom cylinder 20, the arm cylinder 21, traveling motors 23, 24, and the revolving motor 25. In the hydraulic circuit diagram of FIG. 2, these are illustrated as typical hydraulic actuators, and illustration of other hydraulic actuators is omitted.

The hydraulic actuators individually include direction control valves, respectively. A collection of these direction control valves constitutes the control valve unit V.

Each of the direction control valves has its position switched by a manual operation on each of the manual operation tools mentioned above, to switch an oil supply direction. Each of the direction control valves has a meter-in throttle. The meter-in throttle has its opening degree variable in accordance with an operation amount on each manual operation tool. This, in combination with a control on an ejection flow rate from the hydraulic pump 1 performed by a load-sensing type pump control system 5 (described later), can cause a flow rate of the hydraulic oil supply to each hydraulic actuator to match a required flow rate of each hydraulic actuator, thus reducing an excess flow rate which is a loss because it is returned to a tank without working. In this manner, an increased operation efficiency of the hydraulic oil supply system for supplying hydraulic oil to the hydraulic actuator is attempted. In other words, a required flow rate of each hydraulic actuator is fixed by the opening degree of the meter-in throttle which is set according to an operation amount on the direction control valve of the hydraulic actuator.

In FIG. 2, the manual operation tools of the direction control valves 30, 31, 33, 34, 35 are illustrated as a boom operation lever 30a, an arm operation lever 31a, a first travel operation lever 33a, a second travel operation lever 34a, and a revolving operation lever 35a. Alternatively, however, the manual operation tools may be pedals or switches instead of levers, and may be integrated as appropriate. For example, it may be acceptable that one direction control valve is controlled by turning one lever in one direction, and another direction control valve is controlled by turning the one lever in another direction.

It may be also acceptable that the manual operation tools (levers 30a, 31a, 33a, 34a, 35a) are remote control (pilot) valves, so that the direction control valves 30, 31, 33, 34, 35 are controlled by pilot pressures caused by operations on the manual operation tools.

The revolving excavator work machine 10 also includes a speed change switch 26. The speed change switch 26 is linked to a movable swash plate 23a and a movable swash plate 24a of the first traveling motor 23 and the second traveling motor 24 which are variable displacement type hydraulic motors. As the speed change switch 26 is operated, the movable swash plates 23a, 24a are concurrently tilted. Here, the movable swash plates 23a, 24a of the traveling motors 23, 24 may alternatively operated with a manual operation tool other than a switch, for example, with a pedal or a lever.

In this embodiment, the speed change switch 26 serves as an on/off switch. On-operation of the speed change switch 26 places the movable swash plates 23a, 24a into a small-inclination-angle (small-capacity) position for high-speed (normal-speed) setting, which is suitable for traveling on a road. Off-operation of the speed change switch 26 places the movable swash plates 23a, 24a into a large-inclination-angle (large-capacity) position for low-speed (work-speed) setting, which is suitable for traveling with work.

In more detail, the movable swash plates 23a, 24a are respectively linked to piston rods of swash plate control cylinders 23b, 24b which are hydraulic actuators. An open/close valve 27 is provided for supplying hydraulic oil to the swash plate control cylinders 23b, 24b. When the speed change switch 26 is turned on, the open/close valve 27 is opened by a pilot pressure, to supply hydraulic oil to the swash plate control cylinders 23b, 24b, so that the swash plate control cylinders 23b, 24b push and move the movable swash plates 23a, 24a into the small-inclination-angle position. When the speed change switch 26 is turned off, the open/close valve 27 brings back the hydraulic oil from the swash plate control cylinders 23b, 24b, so that the movable swash plates 23a, 24a are returned to the large-inclination-angle position due biasing with springs of the piston rods.

The hydraulic pump 1, a relief valve 3, and the load-sensing type pump control system 5 are combined to constitute the pump unit PU. The relief valve 3 prevents an excessive ejection pressure of the hydraulic pump 1. The load-sensing type pump control system 5 is constituted by a combination of a pump actuator 6, a load sensing valve 7, and a pump control proportional valve 8.

The pump actuator 6 is constituted by a hydraulic cylinder, and its piston rod 6a is linked to a movable swash plate 1a of a first hydraulic pump 1. Expansion and contraction of the piston rod 6a causes the movable swash plate 1a to be tilted, thereby changing an inclination angle of the movable swash plate la. In this manner, an ejection flow rate QP from the hydraulic pump 1 is changed.

The load sensing valve 7 has a supply/discharge port that is in communication with a pressure oil chamber 6b of the pump swash plate actuator 6. The pressure oil chamber 6b is for expansion of the piston rod. The load sensing valve 7 is biased by a spring 7a, in a direction of letting oil out of the pressure oil chamber 6b of the pump swash plate actuator 6, that is, in a direction of contracting the piston rod 6a. The direction in which the piston rod 6a contracts is toward the side where the inclination angle of the movable swash plate la increases, that is, the side where the ejection flow rate from the hydraulic pump 1 increases.

Oil ejected from the hydraulic pump 1 is partially received by the load sensing valve 7, to serve as hydraulic oil to be supplied to the pressure oil chamber 6b of the pump swash plate actuator 6. Part of this oil is, against the spring 7a, applied to the load sensing valve 7, to serve as a pilot pressure that is based on an ejection pressure P_{P} of the hydraulic pump 1. The ejection pressure P_{P} serving as the pilot pressure applied to the load sensing valve 7 is exerted so as to switch the load sensing valve 7 in a direction of supplying oil to the pressure oil chamber 6b of the pump swash plate actuator 6, that is, in a direction of expanding the piston rod 6a.

From all hydraulic pressures at secondary sides after the meter-in throttles of all the direction control valves, that is, from all hydraulic pressures of supply oils from the direction control valves to the hydraulic actuators, a maximum hydraulic pressure which means a maximum load pressure P_{L} is extracted, and is applied to the load sensing valve 7 to serve as a pilot pressure against the ejection pressure P_{P}.

Here, a flow rate of oil passing through the meter-in throttle of each direction control valve and supplied to the corresponding hydraulic actuator, that is, a required flow rate Q_{R} of each hydraulic actuator is calculated by mathematical expressions indicated as “Math. 1” below.

$${Q}_{R} = cA \sqrt{\frac{2 Δ P}{ρ}} \\ Δ {P}_{0} = {P}_{p} - {P}_{L} \\ Δ P = Δ {P}_{0} - {P}_{C} \qquad [ Math . 1 ]$$

Q_{R}=required flow rate

c=coefficient

A=meterin throttle opening degree (cross-sectional area)

ΔP=differential pressure

ρ=density

ΔP₀=uncontrolled differential pressure (specified differential pressure)

P_{P}=ejection pressure

P_{L}=(maximum) load pressure

P_{C}=control pressure

Assuming that the control pressure P_{C} (described later) is zero, the position of the load sensing valve 7 is switched depending on whether the differential pressure ΔP (uncontrolled differential pressure ΔP₀) between the ejection pressure P_{P} and the maximum load pressure P_{L} is higher or lower than a spring force Fs of the spring 7a. When the differential pressure ΔP, is higher than the spring force Fs, the piston rod 6a of the pump actuator 6 expands so that the inclination angle of the movable swash plate 1a decreases to reduce the ejection flow rate Q_{P} of the hydraulic pump 1. When the spring force Fs is higher than the differential pressure ΔP, the piston rod 6a of the pump actuator 6 contracts so that the inclination angle of the movable swash plate 1a increases to increase the ejection flow rate Q_{P} of the hydraulic pump 1.

The expressions above indicate that the required flow rate Q_{R} is proportional to the opening degree A (cross-sectional area) of the meter-in throttle, if the differential pressure ΔP is constant. The opening degree A of the meter-in throttle is determined according to an operation amount on the manual operation tool of the direction control valve in which this meter-in throttle is provided. In other words, the required flow rate Q_{R} is a value that is determined irrespective of a change in the engine rotation number. The required flow rate Q_{R} is kept constant, as long as the operation amount is kept constant.

If, due to an insufficient ejection flow rate Q_{P} from the hydraulic pump 1, a supply flow rate to an operation-object hydraulic actuator through the meter-in throttle of the direction control valve is less than the required flow rate Q_{R} of the hydraulic actuator; the differential pressure ΔP decreases and falls below the spring force Fs so that the load sensing valve 7 is operated in the direction of increasing the inclination angle of the movable swash plate 1a, which increases the ejection flow rate Q_{P} from the hydraulic pump 1, thus increasing the supply flow rate to this hydraulic actuator. In this manner, a driving speed of this hydraulic actuator can be increased to a speed set by the manual operation tool of this hydraulic actuator.

If the ejection flow rate Q_{P} from the hydraulic pump 1 is too high, the differential pressure ΔP increases and exceeds the spring force Fs so that the load sensing valve 7 is operated in the direction of reducing the inclination angle of the movable swash plate 1a, which reduces the ejection flow rate Q_{P} from the hydraulic pump 1, thus reducing the supply flow rate to the hydraulic actuator to a value corresponding to the required flow rate Q_{R} of this hydraulic actuator. In this manner, an excessive supply amount of hydraulic oil can be reduced.

Even when, for example, an operation amount on each lever (a spool stroke of each direction control valve) is at its maximum (that is, the opening degree of the meter-in throttle of each direction control valve is at its maximum), the required flow rate Q_{R} varies depending on an operation-object hydraulic actuator. For example, a required flow rate of the boom cylinder 20 for turning the boom 16 is high. On the other hand, a required flow rate of the revolving motor 25 for turning the revolving base 12 is not so high.

Although the required flow rates of the individual actuators are different from one another, controlling the inclination angle of the movable swash plate 1a in such a manner that the differential pressure ΔP in the load sensing valve 7 can be equal to a differential pressure (target differential pressure) specified by the spring force Fs of the spring 7a as mentioned above allows the hydraulic pump 1 to supply oil with a flow rate corresponding to a required flow rate specified by the direction control valve of each actuator. That is, for all the actuators, the inclination angle (pump capacity) of the movable swash plate 1a of the hydraulic pump 1 is controlled with targeting a ratio (Q/Q_{R}) (hereinafter referred to as “supply/required flow rate ratio”) of the supply flow rate Q to the required flow rate Q_{R} being 1 (hereinafter, this target value will be referred to as “target supply/required flow rate ratio Rq”).

If the inclination angle of the movable swash plate 1a is set constant, the ejection flow rate Q_{P} from the hydraulic pump 1 is changed with a change in an engine rotation number N.

Supply flow rate characteristics in a case of alternating turning of the boom 16 with the boom operation lever 30a operated to its maximum operation amount and turning of the revolving base 12 with the revolving operation lever 35a operated to its maximum operation amount will now be discussed with reference to FIG. 4, on the assumption that the target differential pressure ΔP in the load sensing valve 7 is equal to the specified differential pressure ΔP₀ specified by the spring force Fs irrespective of a change in the engine rotation number (that is, over the entire region of the engine rotation number, for driving of all the actuators, the movable swash plate 1a of the pump 1 is controlled with targeting the target supply/required flow rate ratio Rq being 1 (Rq=1)).

FIG. 4 shows characteristics of the supply flow rate Q to the hydraulic actuator over the entire region of the engine rotation number N which is set for operations of the hydraulic actuators (shown herein are characteristics of a supply flow rate Qb to the boom cylinder 20 and a supply flow rate Qs to a revolving cylinder 23). A minimum value and a maximum value of the region of the engine rotation number N are a low idling rotation number N_{L} and a high idling rotation number N_{H}, respectively. The inclination angle of the movable swash plate 1a is indicated by Θ_{NH} and Θ_{NL}. Θ_{NH} represents the inclination angle at a time of driving the engine with the high idling rotation number N_{H} (hereinafter referred to as “at a time of high idling rotation”). Θ_{NL} represents the inclination angle at a time of driving the engine with the low idling rotation number N_{L} (hereinafter referred to as “at a time of low idling rotation”).

FIG. 4 shows a change in a maximum rate Q_{PMAX} of the pump ejection flow rate Q_{P} (hereinafter, maximum ejection flow rate Q_{PMAX}) over the engine rotation-number region, in a case where the movable swash plate 1a is at its maximum inclination angle position. The supply flow rate Q is a flow rate that is actually supplied to each actuator via the direction control valve. As long as each actuator is driven solely; for each driving, the load-sensing type pump control system 5 controls the ejection flow rate Q_{P} from the hydraulic pump 1 such that the ejection flow rate Q_{P} can correspond to the required flow rate Q_{R}. As a result, therefore, the ejection flow rate Q_{P}=the supply flow rate Q can be established. This is an assumption on which the following description depends.

As long as the target differential pressure ΔP is set to the specified differential pressure ΔP₀; each time each actuator is operated, the inclination angle of the movable swash plate 1a is controlled such that oil ejected from the pump 1 can be supplied so as to satisfy the required flow rate Q_{R} of the actuator, that is, such that the target supply/required flow rate ratio Rq can be 1.

A required flow rate Qb_{R} of the boom cylinder 20 with the boom operation lever 30a operated to its maximum operation amount is determined by a maximum opening area S_{MAX} (see FIG. 7) of the meter-in throttle of the direction control valve 30. The required flow rate Qb_{R} is lower than a pump maximum ejection flow rate Q_{PHMAX} at a time of high idling rotation. Thus, an inclination angle Θb1 of the movable swash plate 1a in a case of driving the boom 16 at a time of high idling rotation is equal to or smaller than a maximum inclination angle Θ_{MAX} (in this embodiment, smaller than the inclination angle Θ_{MAX}). That is, at a time of high idling rotation, the supply flow rate Qb to the boom cylinder 20 equals the required flow rate Qb_{R}. Thus, at a time of high idling rotation, the supply flow rate Qb to the boom cylinder 20 has a maximum value, and a driving speed of the boom 16 exerted at this time is a maximum driving speed.

The required flow rate Qb_{R} of the boom cylinder 20 is constant while the required flow rate Qb_{R} of the boom cylinder 20 is relatively higher among all the actuators. Therefore, as long as the operation amount on the boom operation lever 30a is kept at the maximum value, the maximum ejection flow rate Q_{PMAX} decreases as the engine rotation number N decreases from the high idling rotation number N_{H}, and eventually (at a time point when the engine rotation number N reaches N₁ in FIG. 4), the maximum ejection flow rate Q_{PMAX} itself becomes equal to the required flow rate Qb_{R} of the boom cylinder 20. While the engine rotation number N is decreasing from N_{H} to N₁, the load-sensing type pump control system 5 increases the inclination angle of the movable swash plate 1a in order to attain the target supply/required flow rate ratio Rq (=1) of the boom cylinder 20. At a time point when the engine rotation number N=N₁, the inclination angle of the movable swash plate 1a reaches the maximum angle Θ_{MAX}.

While the engine rotation number N having fallen below N₁ is decreasing to the low idling rotation number N_{L}, the maximum ejection flow rate Q_{PMAX} falls below the required flow rate Qb_{R} of the boom cylinder 20. Consequently, as the engine rotation number decreases, the supply flow rate Qb to the boom cylinder 20 overlaps the maximum ejection flow rate Q_{PMAX} and decreases together with the maximum ejection flow rate Q_{PMAX}. Along with the decrease in the supply flow rate Qb, the operating speed of the boom cylinder 20 which means the driving speed of the boom 16 decreases.

A required flow rate Q_{SR} of the revolving motor 25 with the revolving operation lever 35a operated to its maximum operation amount is determined by a maximum opening area S_{MAX} (see FIG. 7) of the meter-in throttle of the direction control valve 35. To satisfy the required flow rate Q_{SR}, at a time of high idling rotation, the movable swash plate 1a of the hydraulic pump 1 is placed with an inclination angle ΘS1, so that the revolving cylinder 23 is operated at its maximum speed, that is, the revolving base 12 is revolved at its maximum speed. At a time of high idling rotation, therefore, alternating the driving of the boom cylinder 20 with the boom operation lever 30a operated to its maximum operation amount and the driving of the revolving motor 25 with the revolving operation lever 35a operated to its maximum operation amount allows both the boom 16 and the revolving base 12 to be turned at their respective maximum driving speeds.

The required flow rate Q_{SR} of the revolving cylinder 23 with the revolving operation lever 35a operated to its maximum operation amount is considerably lower than the required flow rate Qb_{R} of the boom cylinder 20 with the boom operation lever 30a operated to its maximum operation amount. At a time of high idling rotation, the inclination angle ΘH of the movable swash plate 1a is considerably smaller than the inclination angle Θb1 in a case of operating the boom cylinder 20 with the boom operation lever 30a operated to its maximum operation amount. Thus, there is a considerable tilt allowable range before reaching the maximum inclination angle Θₘₐₓ.

While the engine rotation number N is decreasing from the high idling rotation number N_{H} with the amount of operation on the revolving operation lever 35a being kept at the maximum operation amount, the movable swash plate 1a is tilted in the direction of increasing the inclination angle Θ such that the supply flow rate Qs can satisfy the required flow rate Q_{SR}, under a pump control that the load-sensing type pump control system 5 performs with targeting the target supply/required flow rate ratio Rq being 1. Since the tilt allowable range is wide, the maximum inclination angle Θ_{MAX} is not reached even though the engine rotation number N decreases to the low idling rotation number N_{L} so that the movable swash plate 1lais tilted in the angle increasing direction to the maximum and eventually reaches an inclination angle Θs2. Accordingly, while the engine rotation number N is decreasing to the low idling rotation number N_{L}, the supply flow rate Qs to the revolving cylinder 23 satisfies the required flow rate Q_{SR}, and the operating speed of the revolving motor 25 is kept at the maximum speed so that the revolving speed of the revolving base 12 is also kept at the maximum speed.

As described above, the driving speed of the boom 16 at a time of low idling rotation is lower than that at a time of high idling rotation, whereas the driving speed of the revolving base 12 at a time of low idling rotation is kept equal to that at a time of high idling rotation. In this situation, if an operator turns the boom 16 at a slow speed on the assumption that the engine E is driven with the low idling rotation number N_{L} and then shifts to an operation of turning the revolving base 12, the turning speed is higher than the operator has expected, which makes the operator feel uncomfortable in performing the operation. Moreover, even though the operator desires to move the revolving base 12 at a minute speed, the revolving speed of the revolving base 12 is not changed by reduction in the engine rotation number. The speed can be adjusted only by adjustment of the revolving operation lever 35a. Thus, a delicate revolving operation of the machine is difficult.

If the target supply/required flow rate ratios Rq for all the actuators are reduced at a constant ratio so as to correspond to a decrement of the engine rotation number, and the load-sensing type pump control system 5 performs the pump control; the supply flow rates Q to the respective actuators at a time of operating the actuators are uniformly reduced so as to correspond to the decrement of the engine rotation number N, irrespective of high/low of their required flow rates Q_{R}. Accordingly, the driving speeds of the respective drive units driven by the respective actuators can be reduced uniformly.

For example, in a case of alternating turning of the boom 16 and turning of the revolving base 12 as described above; at a time of low idling rotation, the turning of the revolving base 12 can be made slow down with a sensation equivalent to slow-down of the turning of the boom 16 as compared to at a time of high idling rotation. Thus, an inconvenience that the operator feels as if the turning of the revolving base 12 is relatively high as compared to the turning of the boom 16 can be removed.

Under such a pump control, the driving speed of the revolving motor 25 decreases as the engine rotation number decreases, and therefore it is possible to delicately adjust the position of the revolving base 12 by minutely adjusting the speed of the revolving motor 25 based on increase and decrease in the engine rotation number, which would be impossible if the pump control is performed with the target supply/required flow rate ratio Rq=1 being fixed.

To reduce the target supply/required flow rate ratios Rq for all the actuators in accordance with a decrease in the engine rotation number, the load-sensing type pump control system 5 is provided with an electromagnetic proportional valve serving as the pump control proportional valve 8. Oil from the pump control proportional valve 8 is, as pilot pressure oil, supplied to the load sensing valve 7. A secondary pressure of the load sensing valve 7 having this oil is the control pressure P_{C} which is applied to the load sensing valve 7 against the maximum load pressure P_{L}.

A differential pressure between the ejection pressure P_{P} and the maximum load pressure P_{L} required to balance the spring force Fs, which means the target differential pressure ΔP, is reduced by an amount corresponding to addition of the control pressure P_{C}. Accordingly, as the control pressure P_{C} increases, the load sensing valve 7 operates in the direction of reducing the inclination angle of the movable swash plate 1a, so that the ejection flow rate from the hydraulic pump 1 decreases.

The control pressure P_{C} is determined by a current value that is applied to a solenoid 8a of the pump control proportional valve 8 which is an electromagnetic proportional valve. This value is defined as a control output value C. For the direction control valve of each hydraulic actuator, a correlation of the required flow rate of each hydraulic actuator with the operation amount on the manual operation tool of this hydraulic actuator is estimated with respect to each engine rotation number. A correlation map of the control output value C corresponding to the engine rotation number is prepared so as to achieve the estimated correlation. This map is stored in a storage unit of the controller that controls the control output value to be applied to the pump control proportional valve 8. This is how to enable the supply/required flow rate ratios of all the hydraulic actuators to be controlled so as to correspond to a change in the engine rotation number (that is, how to enable a control under which the driving speeds of the plurality of actuators decrease at the same ratio in accordance with the engine rotation number), as described above. Based on this map, the target values of the supply/required flow rate ratios for all the hydraulic actuators, which intrinsically should be 1, are reduced in accordance with a decrease in the engine rotation number. This control will hereinafter be referred to as “speed reducing control” in the following description.

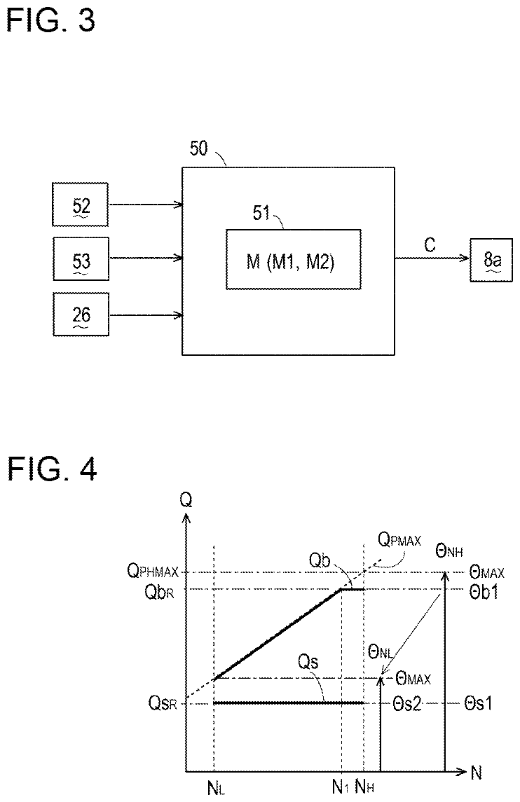

In the revolving excavator work machine 10, a control system for the hydraulic actuators as shown in FIG. 3 is structured. A controller 50 includes a storage unit 51 that stores therein a correlation map M of the control output value C in correlation with the engine rotation number N, for every actuator.

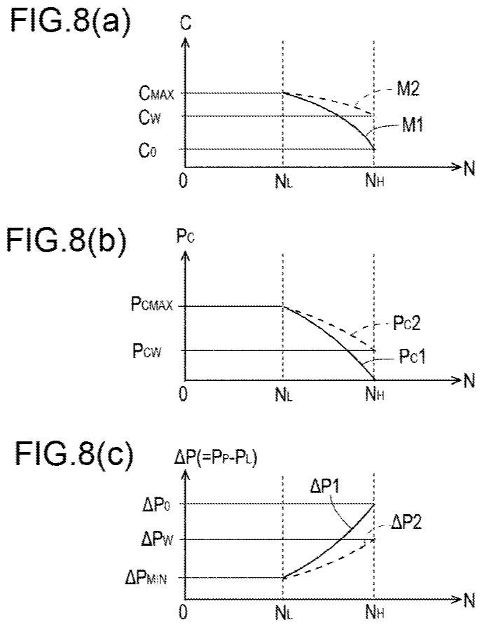

The correlation map M of the control output value C in correlation with the engine rotation number N, which is stored in the storage unit 51, is prepared for each work mode. In the revolving excavator work machine 10, some work modes can be set. The present application particularly mentions only a standard map M1 selected in normal mode setting and a low speed travel map M2 selected in low speed travel mode setting as shown in FIG. 8(a). In addition to them, for example, a fuel saving mode having a smaller high idling rotation number than in a normal state may be set in the revolving excavator work machine 10. A map of the control output value C for use in setting the fuel saving mode may be included in the map group mentioned above.

The controller 50 receives a detection signal about an engine rotation number from the engine rotation number detection unit 52, and an on-off signal of the speed change switch 26. The controller 50 also receives, from traveling detection means 53, a traveling detection signal indicating a determination result of whether or not the revolving excavator work machine 10 is actually traveling (that is, whether or not the traveling motors 23, 24 are driven). The traveling detection means 53 may alternatively configured to detect operation amounts on the travel operation levers 33a, 34a (for example, if the operation amounts on both of the levers 33a, 34a are zero, it is determined that the revolving excavator work machine 10 is not traveling.

The on-off signal of the speed change switch 26 and the traveling detection signal from the traveling detection means 53 are related to which of the standard map M1 and the low speed travel map M2 is to be selected. It may be conceivable that the controller 50 receives not only them but also, for example, a signal from a switch that is on-operated in setting the fuel saving mode, and the like, instead of selection of the map for use in the fuel saving mode.

Based on these signals received, the controller 50 determines a set mode, and selects a map corresponding to the set mode from a group of correlation maps of the control output value C in correlation with the engine rotation number N, which is stored in the storage unit 51. The controller 50 applies the engine rotation number N that is based on the signal received from the engine rotation number detection unit 52 to the selected map, thereby determining a target value for the control output value C.

How one of the standard map M1 and the low speed travel map M2 is selected based on the received signals mentioned above will be detailed later with reference to FIG. 8 to FIG. 10.

Based on this determination, the controller 50 applies a current having the determined control output value C to the solenoid 8a of the pump control proportional valve 8 in the load-sensing type pump control system 5, and causes pilot pressure oil having a control pressure P_{C} generated by the application of the control output value C to be supplied from the pump control proportional valve 8 to the load sensing valve 7, to thereby control the inclination angle of the movable swash plate 1a of the hydraulic pump 1, that is, the ejection flow rate from the hydraulic pump 1, via the pump actuator 6.

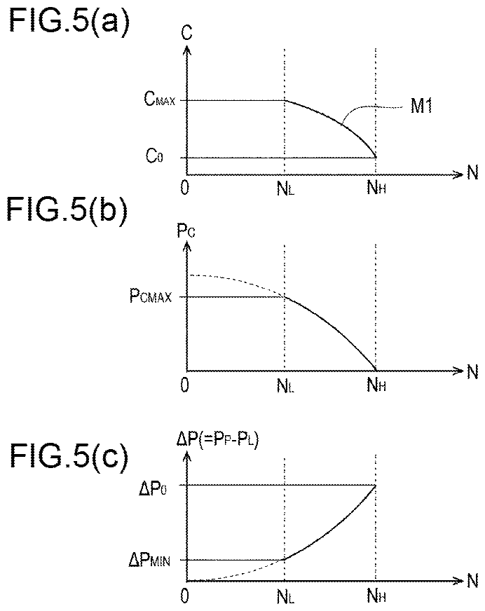

Referring to FIG. 5 to FIG. 7, a description will be given to a map of the control output value C, and a manner of the pump control based on the map, in relation to the “speed reducing control”.

FIG. 5(a) shows the standard map M1 indicating a change in the control output value C along with a decrease of the engine rotation number N from the high idling rotation number N_{H} to the low idling rotation number N_{L}. Here, a configuration of the standard map Ml, which is typical one in the group of maps prepared for each of several modes that can be set in the revolving excavator work machine 10 as mentioned above, will be described.

In the standard map M1, the control output value C at a time of high idling rotation serves as a minimum value C₀ (which means a value that causes the secondary pressure (control pressure P_{C}) of the pump control proportional valve 8 to be zero), the control output value C at a time of low idling rotation serves as a maximum value C_{MAX}, and the control output value C increases as the engine rotation number N decreases from the high idling rotation number N_{H} to the low idling rotation number N_{L}.

FIG. 5(b) and FIG. 5(c) show changes in pressures applied to the load sensing valve 7 in a case of changing the control output value C for the pump control proportional valve 8 (the current value applied to the solenoid 8a) in accordance with a change in the engine rotation number N based on the standard map M1. FIG. 5(b) shows a change in the secondary pressure of the pump control proportional valve 8, that is, a change in the control pressure P_{C}. FIG. 5(c) shows a change in the target value for the differential pressure ΔP between the ejection pressure P_{P} and the maximum load pressure P_{L}, that is, a change in the target differential pressure ΔP.

At a time of high idling rotation, the control output value C is the minimum value C₀, and therefore the control pressure P_{C} is 0. Accordingly, the target differential pressure ΔP is the specified differential pressure ΔP₀ which is equal to the spring force Fs of the load sensing valve 7. As the engine rotation number N decreases from the high idling rotation number N_{H} to the low idling rotation number N_{L}, the control output value C increases so that the control pressure P_{C} increases, and accordingly, the target differential pressure ΔP decreases. The target differential pressure ΔP at a time of low idling rotation is defined as a minimum target differential pressure ΔP_{MIN}.

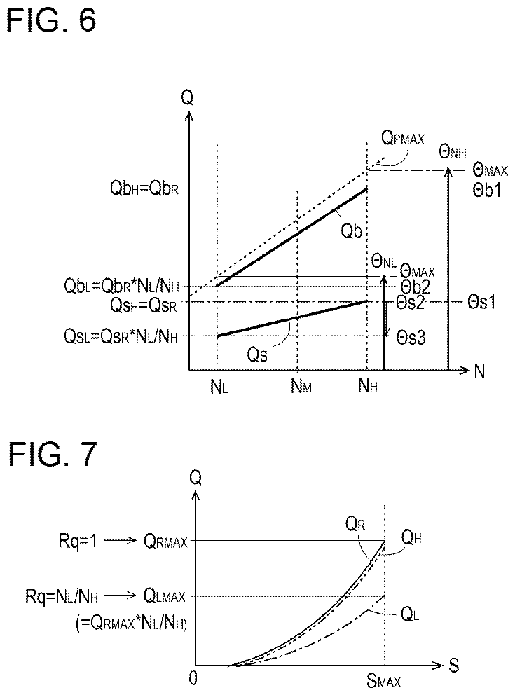

FIG. 6 is a diagram showing an effect of the “speed reducing control” that appears in the supply flow rate characteristics of the hydraulic actuators in accordance with a change in the engine rotation number. This diagram is on the assumption of a work state in which two hydraulic actuators (herein, the boom cylinder 20 and the revolving motor 25) having different required flow rates are operated alternately (that is, each of them is operated solely). Illustrated are a graph of the pump supply flow rate Qb in a case of driving the boom cylinder 20 whose required flow rate is high and a graph of the supply flow rate Qs in a case of driving the revolving motor 25 whose required flow rate is low. Also illustrated is a graph of the maximum ejection flow rate Q_{PMAX}, similarly to FIG. 4. They are values obtained when the operation amounts on the respective operation levers 30a, 35a are maximum (when spool strokes S of the respective direction control valves 30, 35 are the maximum values S_{MAX}), that is, when their required flow rates Qb_{R}, Q_{SR} are maximum. The inclination angle of the movable swash plate 1a is represented as Θ_{NH} at a time of high idling rotation, and as Θ_{NL} at a time of low idling rotation, as mentioned above.

At a time of high idling rotation (N=N_{H}), the control output value C for the pump control proportional valve 8 is the minimum value C₀, and thus no control pressure P_{C} is applied to the load sensing valve 7 (that is, the target differential pressure ΔP is the specified differential pressure ΔP₀). For each actuator, therefore, the movable swash plate 1a is controlled with the target supply/required flow rate ratio Rq=1. Accordingly, as in the case of high idling rotation described with reference to FIG. 4, when the boom cylinder 20 is driven, the movable swash plate 1a reaches the inclination angle Θb1 so that the supply flow rate Qb_{H} satisfies the required flow rate Qb_{R} (Qb_{H}=Qb_{R}), to drive the boom 16 at its maximum speed, whereas when the revolving motor 25 is driven, the movable swash plate 1a reaches the inclination angle Θs1 so that the supply flow rate Q_{SH} satisfies the required flow rate Q_{SR} (Q_{SH}=Q_{SR}), to revolve the revolving base 12 at its maximum speed.

At a time of low idling rotation (N=N_{L}), on the other hand, the control output value C for the pump control proportional valve 8 is the maximum value C_{MAX} which is greater than the minimum value C₀, and thus a control pressure P_{C} is applied to the load sensing valve 7, so that the target differential pressure ΔP is [the specified differential pressure ΔP₀—the control pressure ΔP_{C}], which is lower than the target differential pressure ΔP at a time of high idling rotation. Accordingly, the target supply/required flow rate ratio Rq of each actuator is set to a value smaller than 1 which is the target value at a time of high idling rotation. Here, RqL=N_{L}/N_{H} is set, where RqL is the target supply/required flow rate ratio Rq at a time of low idling rotation. Thus, when the boom cylinder 20 is driven, the inclination angle Θ_{NL} of the movable swash plate 1a is kept as low as Θb2, so that the supply flow rate Qb_{L} for turning decreases Qb_{R}×N_{L}/N_{H}. On the other hand, when the revolving motor 25 is driven, the inclination angle Θ_{NL} of the movable swash plate 1a would be able to reach Θs2 if the speed reducing control was not performed, but actually, the inclination angle Θ_{NL} is kept as low as Θs3 which is lower than Θs2, so that the supply flow rate Θ_{SL} decreases Q_{SR}×N_{L}/N_{H}. In this manner, for both the boom cylinder 20 and the revolving motor 25, the supply flow rates Q decrease at the same ratio along with a decrease in the engine rotation number from the high idling rotation number to the low idling rotation number, and the driving speeds of the boom cylinder 20 and the revolving motor 25 also decrease at the same ratio.

In a case of driving the engine E with an arbitrary engine rotation number N_{M} intermediate between the high idling rotation number N_{H} and the low idling rotation number N_{L}, the target supply/required flow rate ratio Rq in driving each actuator is set to N_{M}/N_{H}. The arbitrary engine rotation number N_{M} is a numerical value that decreases toward the low idling rotation number N_{L}. Thus, as the engine rotation number N decreases toward the low idling rotation number N_{L}, the target supply/required flow rate ratio Rq in driving each actuator decreases.

Setting the target supply/required flow rate ratio Rq corresponding to the arbitrary engine rotation number N_{M} to N_{M}/N_{H} is one example of causing a decrease in the supply flow rate Q in driving each actuator, which occurs along with a decrease in the target engine rotation number N, to be according to a decrease in the engine rotation number. Other numerical values may be set. The important thing is that the target supply/required flow rate ratio Rq decreases along with a decrease in the target engine rotation number N from the high idling rotation number N_{H}, and that each time each actuator is operated, the effect of decreasing the target supply/required flow rate ratio Rq in accordance with a decrease in the engine rotation number can be obtained for all the actuators.

In the case described with reference to FIG. 4, for the boom cylinder 20 whose required flow rate Qb_{R} with the boom operation lever 30a operated to the maximum operation amount is high, the target differential pressure ΔP is not changed (the target supply/required flow rate ratio Rq=1 is maintained) even though the engine rotation number is changed. In this case, a decrease in the supply flow rate Qb along with a decrease in the engine rotation number N is almost attributable to a decrease in the maximum ejection flow rate Q_{PMAX} along with the degrease in the engine rotation number N. Referring to FIG. 6, it can be seen that: if the supply flow rate Qb for the boom cylinder 20 with the boom operation lever 30a operated to the maximum operation amount is set to Qb_{R}×N_{M}/N_{H} so as to correspond to the arbitrary engine rotation number N_{M}, a decrease in the supply flow rate Qb along with a decrease in the engine rotation number roughly follows a decrease in the maximum ejection flow rate Q_{PMAX}.

In the case described with reference to FIG. 4, for the revolving motor 25 whose required flow rate Q_{SR} with the revolving operation lever 35a operated to the maximum operation amount is low, the target differential pressure ΔP is not changed (the target supply/required flow rate ratio Rq=1 is maintained) even though the engine rotation number is changed. In this case, the supply flow rate Qs is kept at a value that satisfies the required flow rate Q_{SR} over the entire region of the engine rotation number N from the high idling rotation number N_{H} to the low idling rotation number N_{L}. Referring to FIG. 6, it can be seen that: if the supply flow rate Qs for the revolving motor 25 with the revolving operation lever 35a operated to the maximum operation amount is set to Q_{SR}×N_{M}/N_{H} so as to correspond to the arbitrary engine rotation number N_{M}, the supply flow rate Qs decreases along with a decrease in the engine rotation number, and the decrease in the supply flow rate Qs is according to the decrease in the engine rotation number.

The effect of decreasing the target supply/required flow rate ratio Rq by increasing the control output value C shown in FIG. 5(a) along with a decrease in the engine rotation number is, in appearance, significantly exerted for an actuator required flow rate is low, because a supply flow rate for such an actuator decreases though it has been conventionally kept to satisfy a required flow rate even at a time of low-speed rotation of the engine. The effect is not obviously exerted for an actuator whose required flow rate is high, because a decrease in a supply flow rate for such an actuator along with a decrease in the engine rotation number is similar to a decrease in the maximum ejection flow rate Q_{PMAX}. The fact, however, remains that the effect of controlling the control output value C, the control pressure P_{C}, and the target differential pressure ΔP shown in FIG. 5(a) to FIG. 5(c) in accordance with a change in the engine rotation number can be obtained also for a hydraulic actuator whose required flow rate is high, such as the boom cylinder 20. Thus, for every actuator, the effect of decreasing the driving speed of the actuator by decreasing the target supply/required flow rate ratio Rq in accordance with the engine rotation number can be obtained upon driving the actuator.

Consequently, for all the actuators, a phenomenon is avoided that: with lever positions of the actuators unchanged, the driving speeds of the actuators decrease uniformly (for example, according to a decrease in the engine rotation number) along with a decrease in the engine rotation number, to make the operator feel as if driving of one actuator is relatively high as compared to another actuator while the engine is driven with a low engine rotation number.

For an actuator whose required flow rate is low, such as the revolving motor 25, the speed of the actuator can be minutely adjusted by changing the engine rotation number, which is impossible if the target supply/required flow rate ratio Rq is fixed to 1.

Regarding the speed reducing control in accordance with a change in the engine rotation number, FIG. 7 shows characteristics of the required flow rate Q_{R} and the supply flow rate Q relative to a lever operation amount on a certain hydraulic actuator, that is, relative to a spool stroke S of a direction control valve of the actuator. The required flow rate Q_{R} increases as the spool stroke S increases, and reaches a maximum value Q_{RMAX} when the spool stroke S is a maximum stroke S_{MAX}. Without any control output under the speed reducing control, as in the case of high idling rotation, the supply/required flow rate ratio is 1 so that a supply flow rate Q_{H} is coincident with the required flow rate Q_{R}, unless the required flow rate Q_{R} exceeds the maximum pump ejection flow rate Q_{PMAX}. On the other hand, a supply flow rate Q_{L} at a time of low idling rotation has a value obtained by multiplying the required flow rate Q_{R} by a constant ratio (in the above embodiment, N_{L}/N_{H}) less than 1, because of the speed reducing control effect. That is, when the spool stroke S is the maximum stroke S_{MAX}, Q_{LMAX}=Q_{RMAX}×N_{L}/N_{H} is established. This correspondence relation is maintained irrespective of a state of the operation amount (spool stroke S). Even under the speed reducing control, the pump supply flow rate Q_{L} at a time of low idling rotation increases along with an increase in the lever operation amount, and the operating speed of the actuator also increases.

In the revolving excavator work machine 10, regarding the speed reducing control, selection of the standard map M1 or the low speed travel map M2 shown in FIG. 8(a) is made based on selection of the normal mode or the low speed travel mode, as mentioned above.

Referring to FIG. 3, if the controller 50 determines that the movable swash plates 23a, 24a of the traveling motors 23, 24 are at the small-inclination-angle (small-capacity) position (normal-speed position) based on signals from the speed change switch 26 and from the traveling detection means 53; the controller 50 selects the standard map M1 from the map group stored in the storage unit 51, to set the revolving excavator work machine 10 into the normal mode, irrespective of whether or not the traveling motors 23, 24 are actually in a driving state (traveling state).

If the controller 50 determines that the movable swash plates 23a, 24a of the traveling motors 23, 24 are at the large-inclination-angle (large-capacity) position (low-speed position); the controller 50 selects the standard map M1, to set the revolving excavator work machine 10 into the normal mode, unless the traveling motors 23, 24 are in the driving state (traveling state). Upon determining that the traveling motors 23, 24 are actually in the driving state (traveling state), the controller 50 selects the low speed travel map M2 from the map group stored in the storage unit 51, to set the revolving excavator work machine 10 into the low speed travel mode. In other words, the low speed travel map M2 is selected only when the traveling motors 23, 24 are actually driven with the movable swash plates 23a, 24a at the low-speed position.

In the standard map M1, the control output value C at a time of high idling rotation serves as the minimum value C₀ (which means a control output value that causes the control pressure P_{C} to be zero), the control output value C increases as the engine rotation number N decreases, and the control output value C at a time of low idling rotation serves as the maximum value C_{MAX}. In the low speed travel map M2, the control output value C at a time of high idling rotation is a value C_{W} which is greater than the minimum value C₀, the control output value C increases as the engine rotation number N decreases, and the control output value C at a time of low idling rotation serves as the maximum value C_{MAX} similarly to the case of the normal mode setting.

The standard map M1 is set so as to make the control output value C increase from the minimum value C₀ to the maximum value C_{MAX} along with a decrease in the engine rotation number N from the high idling rotation number N_{H} to the low idling rotation number N_{L}, whereas the low speed travel map M2 is set so as to make the control output value C increase from the value C_{W} which is greater than the minimum value C₀ to the maximum value C_{MAX} at an increasing rate higher than that of the control output value C in the standard map M1 along with a decrease in the engine rotation number N from the high idling rotation number N_{H} to the low idling rotation number N_{L}.

FIG. 8(b) and FIG. 8(c) show changes in pressures applied to the load sensing valve 7 in a case of changing, based on the maps M1, M2, the control output value C for the pump control proportional valve 8 (the current value applied to the solenoid) in accordance with a change in the engine rotation number N. In FIG. 8(b), a graph P_{C}1 indicates a change in the control pressure P_{C} in normal mode setting, and graph P_{C}2 indicates a change in the control pressure P_{C} in low speed travel mode setting. In FIG. 8(c), a graph ΔP1 indicates a change in the target differential pressure ΔP in normal mode setting, and a graph ΔP2 indicates a change in the target differential pressure ΔP in low speed travel mode setting.

At a time of high idling rotation, in the normal mode setting, the control output value C is the minimum value C₀, and thus the control pressure P_{C} is zero. The target differential pressure ΔP, therefore, is the maximum target differential pressure ΔP₀. At a time of high idling rotation, in the low speed travel mode setting, the control output value C is the value C_{W} which is greater than the minimum value C₀, and thus the control pressure P_{C} having the value P_{CW} greater than zero occurs. Application of the control pressure P_{CW} causes the target differential pressure ΔP to have a value ΔP_{W} which is smaller than the maximum target differential pressure ΔP₀.

That is, at a time of high idling rotation, in the normal mode setting, the control pressure P_{C} is set to zero and no speed reducing control is performed, while in the low speed travel mode setting, the control pressure P_{CW} is applied to perform the speed reducing control (that is, to decrease the target supply/required flow rate ratios Rq) for all the actuators.

At a time of low idling rotation, in the normal mode setting, in order that the target supply/required flow rate ratio Rq can be reduced to N_{L}/N_{H}(<1) as described above, the speed reducing control is performed in which the maximum value C_{MAX} of the control output value C is determined based on the standard map M1, to cause the control pressure P_{C} to be the maximum value P_{CMAX}, thereby causing the target differential pressure ΔP to be the minimum target differential pressure ΔP_{MIN}. At a time of low idling rotation, also in the low speed travel mode setting, the same target supply/required flow rate ratio Rq is adopted (Rq=N_{L}/N_{H}), and the same speed reducing control as in the normal mode setting is performed. That is, the control output value C that corresponds to the low idling rotation number N_{L} on the low speed travel map M2 is the maximum value C_{MAX}, too, which causes the control pressure P_{C} to be the maximum value P_{CMAX}, thereby causing the target differential pressure ΔP to be the minimum target differential pressure ΔP_{MIN}.

It may be acceptable that the control output value C (=C_{MAX}) on the standard map M1 and the control output value C on the low speed travel map M2 are different values at a time of low idling rotation. In such a case, mode switching between the modes at a time of low idling rotation makes the control pressure P_{C} change, thus making the target differential pressure ΔP change, resulting in a change in the target supply/required flow rate ratio Rq.

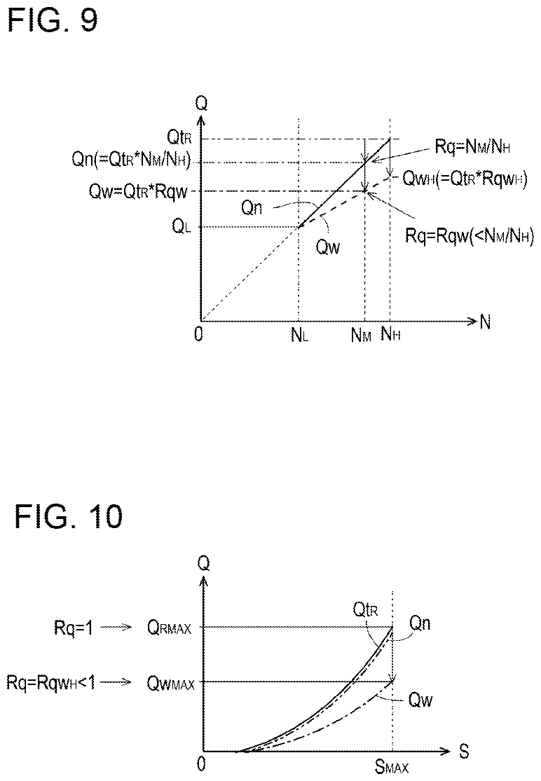

FIG. 9 is a diagram showing an effect of mode switching between the normal mode and the low speed travel mode for the traveling motors 23, 24, the effect appearing in the supply flow rate Q to the traveling motors 23, 24. Here, it is assumed that in both of the modes, the travel operation levers 33a, 34a are operated to the maximum operation amounts (the spool strokes S of the direction control valves 33, 34 have the maximum values S_{MAX}).

At a time of high idling rotation, in the normal mode, an inclination angle of the movable swash plate 1a is determined so as to attain the target differential pressure ΔP_{MAX} in the load sensing valve 7 with no control pressure P_{C} applied (i.e., with no “speed reducing control” performed), that is, so as to attain the target supply/required flow rate ratio Rq=1, based on the standard map M1. Thus, a supply flow rate Qn to the traveling motors 23, 24 with the movable swash plates 23a, 24a placed at the normal-speed position (small-capacity position) satisfies a required flow rate Qt_{R} for the traveling motors 23, 24 (Qn=Qt_{R}).

Likewise, at a time of high idling rotation, in the low speed travel mode, the control output value C is set to C_{W} based on the low speed travel map M2, so that the control pressure P_{CW} is applied to the load sensing valve 7, to cause the target differential pressure ΔP to have the value ΔP_{W} which is smaller than the specified differential pressure ΔP₀ caused under no control pressure P_{C}, thereby setting the target supply/required flow rate ratio Rq to Rqw_{H}(<1) which is smaller than 1 taken in the normal mode. The movable swash plate 1a is tilted so as to satisfy this target supply/required flow rate ratio Rqw_{H}. Thus, a supply flow rate Q_{W} to the traveling motors 23, 24 takes a value Qw_{H}(=Qt_{R}×Rqw_{H}) which is smaller than Qt_{R} taken in the normal mode setting.

The low speed travel map M2 determines a control output value C (C₀<C<C_{MAX}) so as to correspond to an arbitrary engine rotation number N_{M} intermediate between the high idling rotation number N_{H} and the low idling rotation number N_{L}. Based on this control output value C, a control pressure P_{C} is obtained. Based on this control pressure P_{C}, obtained is a target supply/required flow rate ratio Rq having a value Rqw(<N_{M}/N_{H}) further smaller than the value N_{M}/N_{H} which would be obtained in accordance with the same target engine rotation number (the arbitrary engine rotation number N_{M}) in the normal mode. The movable swash plate 1a is tilted so as to satisfy this target supply/required flow rate ratio Rqw. Thus, the supply flow rate Qw to the traveling motors 23, 24 decreases to Qt_{R}×Rqw further lower than the supply flow rate Qn(=Qt_{R}×N_{M}/N_{H}) which would be obtained in accordance with the same engine rotation number N in the normal mode setting.

At a time of low idling rotation, the target supply/required flow rate ratio Rqw=N_{L}/N_{H} is set, and the supply flow rate Q_{L} is not changed by switching between the normal mode and the low speed travel mode (switching of the capacity of the traveling motors 23, 24).

As described above, switching from the standard map M1 to the low speed travel map M2 exerts the effect appearing in the supply flow rate characteristics of the hydraulic actuator (particularly of the traveling motors 23, 24). This means that a value obtained by correcting the target supply/required flow rate ratio Rq which intrinsically should be 1 (by performing the speed reducing control) based on the standard map M1 is additionally corrected (additionally subjected to the speed reducing control) based on the low speed travel map M2, in accordance with an arbitrary engine rotation number N. At a time of high idling rotation, the target supply/required flow rate ratio Rq=1 is set based on the standard map M1, and consequently it appears as if the “speed reducing control” is not performed until adoption of the low speed travel map M2. At a time of low idling rotation, the target supply/required flow rate ratio Rq is set to the same value (N_{L}/N_{H}), and consequently no additional speed reducing control is performed upon switching from the standard map M1 to the low speed travel map M2.

This speed reducing control (correction of the supply/required flow rate ratios for the traveling motors 23, 24) involved in mode switching to the low speed travel mode exerts an effect that, under the same operation amounts on the travel operation levers 33a, 34a and the same engine rotation number, a speed ratio of the traveling speed when the movable swash plates 23a, 24a of the traveling motors 23, 24 are placed at the normal speed position to the traveling speed when they are placed at the low-speed position (or a speed difference between these traveling speeds) is increased. This increase in the speed ratio is significant in a region where the engine rotation number is large, and reaches the maximum at the high idling rotation number.

Accordingly, for example, if a high-rotation engine is provided for the purpose of increasing the on-road traveling speed of the revolving excavator work machine 10; in a high engine rotation speed region near the high idling rotation number N_{H}, for driving of the traveling motors 23, 24 whose movable swash plates 23a, 24a are placed at the normal-speed position (small-capacity setting) in the normal mode setting, no speed reducing control is performed (target supply/required flow rate ratio Rq=1) or a decreasing rate of the target supply/required flow rate ratio Rq is suppressed low, and thereby the engine rotation number in this region increases, whereby the driving speed of the driving sprockets 11b is allowed to be increased (the traveling speed thereof is allowed to be increased) accordingly, whereas adoption of the low speed travel mode causes the traveling motors 23, 24 to be switched to the low-speed position (large-capacity setting) so that the output speed decreases, and in addition, by performing the speed reducing control which means correcting the target supply/required flow rate ratio Rq to a value further smaller than that in the normal mode setting, the inclination angle of the movable swash plate 1a of the hydraulic pump 1 is switched to the decreasing side, so that an increment of the engine rotation number and an increment of the hydraulic pump capacity are compensated, which consequently enables the revolving excavator work machine 10 to travel at a low speed that makes work easily performed as conventional.

To increase the traveling speed difference between when the movable swash plates 23a, 24a of the traveling motors 23, 24 are placed at the normal speed position and when they are placed at the low-speed position, it may be conceivable to change an angular difference between the low-speed position and the normal speed position of the movable swash plates 23a, 24a of the hydraulic motors used as the traveling motors 23, 24. A movable swash plate of a hydraulic motor, however, is designed based on given specifications, and therefore changing the angular difference between the positions requires a change of setting, which is costly. In this respect, the speed reducing control which adopts the existing pump control proportional valve 8 just requires that a map about the control output value C for the pump control proportional valve 8 be changed, which does not involve a cost increase.

The speed reducing control is application of the control pressure P_{C} to the load sensing valve 7, thereby changing the inclination angle of the movable swash plate 1a of the hydraulic pump 1 toward the increasing side. As described above, the speed reducing control exerts the effect of reducing the supply/required flow rate ratio for all the actuators.

Whichever of the normal speed position and the low-speed position the movable swash plates 23a, 24a are placed, the revolving excavator work machine 10 is set to the normal mode if it is determined that the traveling motors 23, 24 are not in the driving state based on the traveling detection signal from the traveling detection means 53 mentioned above. Therefore, while the revolving excavator work machine 10 stops traveling, driving of the other hydraulic actuators, namely, the boom cylinder 20, the arm cylinder 21, the bucket cylinder 22, and the like, is under a supply flow rate control resulting from a control on the control output value C based on the standard map M1 in accordance with the engine rotation number.

In other words, only when the movable swash plates 23a, 24a are placed at the low-speed position, the traveling motors 23, 24 are actually driven, and the revolving excavator work machine 10 travels at a low speed; a supply flow rate to the traveling motors 23, 24 is controlled based on the low speed travel map M2. As for the other actuators, supply flow rates to all of them are controlled based on the standard map M1 so that all of them are operated at operating speeds assumed in the normal mode, unless a situation where the other actuators are driven while the traveling motors 23, 24 are driven occurs during the low speed traveling.

Regarding the speed reducing control in response to switching of the capacity of the traveling motors 23, 24, FIG. 10 shows characteristics of a required flow rate QtR and a supply flow rate Q relative to a lever operation amount on the traveling motors 23, 24 (an operation amount on the travel operation levers 33a, 34a), that is, relative to a spool stroke S of the direction control valves 33, 34, at a time of high idling rotation. The required flow rate Qt_{R} increases as the spool stroke S increases, and reaches a maximum value Q_{RMAX} when the spool stroke S is a maximum stroke S_{MAX}. In the normal mode having the movable swash plates 23a, 24a at the small-inclination-angle (small-capacity) position (normal speed position), no speed reducing control is performed, and therefore the supply/required flow rate ratio is 1 so that the supply flow rate Qn is coincident with the required flow rate QtR. On the other hand, in the low speed travel mode having the movable swash plates 23a, 24a at the large-inclination-angle (large-capacity) position (low-speed position), the supply flow rate Qn has a value obtained by multiplying the required flow rate Qt_{R} by a constant ratio (in the above embodiment, Rqw_{H}) less than 1, due to the effect exerted by the speed reducing control. That is, when the spool stroke S is the maximum stroke S_{MAX}, Qw_{MAX}=Q_{RMAX}×Rqw_{H} is established. This correspondence relation is maintained irrespective of a state of the operation amount (spool stroke S). Even under the speed reducing control, the pump supply flow rate Qw in the low speed travel mode increases along with an increase in the lever operation amount, and the operating speed of the traveling motors 23, 24 which means the rotation speed of the driving sprockets 11b also increases.

As thus far described, the revolving excavator work machine 10 according to an embodiment of the present application is a hydraulic machine including a plurality of hydraulic actuators that are driven by oil ejected from the variable displacement type hydraulic pump 1 driven by the engine E. The pump control system 5 serving as a control device therefor is configured to: in driving each hydraulic actuator, control a flow rate of oil ejected from the hydraulic pump 1 such that the flow rate satisfies the required flow rate Q_{R} for the hydraulic actuator; and correct the target value Rq for the ratio (Q/Q_{R}) of the supply flow rate Q to the required flow rate Q_{R} for each hydraulic actuator, in accordance with a change in the engine rotation number N. The plurality of hydraulic actuators include the traveling motors 23, 24 which are hydraulic motors for traveling of the revolving excavator work machine 10, the traveling motors 23, 24 being configured such that their capacity setting is switchable between at least two different capacity settings. The pump control system 5 is configured to correct the target value Rq for the ratio (Q/Q_{R}) of the supply flow rate Q to the required flow rate Q_{R} for each hydraulic actuator, in accordance with not only a change in the engine rotation number N but also switching of the capacity of the traveling motors 23, 24.

To the plurality of hydraulic actuators, oil ejected from the hydraulic pump 1 is supplied through the meter-in throttle of the direction control valve that is individually provided to each of the hydraulic actuators. The required flow rate Q_{R} for each actuator is defined by the opening degree of the meter-in throttle of the corresponding direction control valve. The pump control system 5 of load-sensing type sets the same target value which is common to all the actuators, for the differential pressure ΔP between the ejection pressure P_{P} of oil ejected from the hydraulic pump 1 and the maximum load pressure P_{L} of oil supplied to each hydraulic actuator. The pump control system 5 is configured to control a flow rate of oil ejected from the hydraulic pump so as to attain the target value for the differential pressure ΔP with respect to all the hydraulic actuators. By correction of the target value for the differential pressure ΔP, correction of the target value Rq for the ratio (Q/Q_{R}) in accordance with a change in the engine rotation number N and correction of the target value Rq for the ratio (Q/Q_{R}) in accordance with switching of the capacity of the traveling motors 23, 24 are implemented.

The load-sensing type pump control system 5 generates the control pressure P_{C} for changing the target value for the differential pressure ΔP, at the secondary pressure of the pump control proportional valve 8 which is an electromagnetic proportional valve. The load-sensing type pump control system 5 stores a plurality of maps as a correlation map of the control output value C in correlation with the engine rotation number N, the control output value C being a current value applied to the pump control proportional valve 8. The plurality of maps include two or more maps M1, M2 each corresponding to each of the at least two capacity settings of the traveling motors 23, 24.

The two or more maps M1, M2 include the standard map M1 corresponding to a small-capacity setting of the traveling motors 23, 24 and the low speed travel map M2 corresponding to a large-capacity setting of the traveling motors 23, 24. In the large-capacity setting of the traveling motors 23, 24, only when it is confirmed that the traveling motors 23, 24 are actually in a driven state, oil ejected from the hydraulic pump 1 is subjected to a flow rate control based on the low speed travel map M2, and otherwise oil ejected from the hydraulic pump 1 is subjected to a flow rate control based on the standard map M1.

The pump control system 5 of the revolving excavator work machine 10 as described above makes it possible to change the ratio (speed ratio) between an output speed of the traveling motors 23, 24 in the large-capacity setting and an output speed thereof in the small-capacity setting. That is, assuming that an operation amount (spool stroke S) on the direction control valves 33, 34 for the traveling motors 23, 24 is kept constant at a constant engine speed, an output speed difference caused by switching of the capacity can be set to a value different from the value specified by specifications of the hydraulic motors serving as the traveling motors 23, 24.

Accordingly, for example, if a high-rotation engine is provided for the purpose of increasing the on-road traveling speed of the revolving excavator work machine 10; a high idling rotation number (the maximum engine rotation speed) is increased, and therefore in a case of the small-capacity setting of the traveling motors 23, 24, the on-road traveling speed can be increased by high-speed engine rotation, whereas in a case of the large-capacity setting, an output speed of the hydraulic motor can be suppressed low so as to be kept at the conventional traveling speed which enables work to be easily performed without any influence of an increase in the high idling rotation number involved in the higher engine rotation.

Changing the speed ratio can be implemented by changing the set position of the movable swash plates 23a, 24a of the traveling motors 23, 24. In such a case, however, a design change is required in relation to a complicated mechanism for positioning the movable swash plates 23a, 24a, which may lead to a cost increase. The pump control system 5 according to an embodiment of the present application is just required to adopt correction of the target value for the differential pressure ΔP between the ejection pressure Pₚ and the maximum load pressure P_{L}, at a time of switching the capacity of the traveling motors 23, 24.

This correction is a configuration that is adopted in an existing load-sensing type pump control system. For example, it is just required that two or more maps each corresponding to each capacity setting of the traveling motors 23, 24 be stored. Accordingly, the pump control system 5 that can exert the above-described effects at low costs can be provided.

Since the correction of the target value for the differential pressure ΔP controls a flow rate of oil ejected from the hydraulic pump 1, correction of the target value Rq for the ratio (Q/Q_{R}) of the supply flow rate Q to the required flow rate Q_{R} is applied not only to the traveling motors 23, 24 but also to all the actuators. In this case, if the output speed of the traveling motors 23, 24 in a case of the large-capacity setting is suppressed low as mentioned above, the traveling speed can be suppressed low, but in addition, the driving speeds of the other actuators are also reduced in response to the traveling motors 23, 24 being switched to the large-capacity setting, which lowers the efficiency of work.

In this respect, in the large-capacity setting of the traveling motors 23, 24, the low speed travel map M2 for the large-capacity setting is used only when it is confirmed that the traveling motors 23, 24 are actually in the driven state. This allows the other actuators to be driven at driving speeds corresponding to the small-capacity setting of the traveling motors 23, 24 irrespective of switching of the capacity of the traveling motors 23, 24. Thus, it is possible to perform work with an efficiency comparable to the efficiency in the small-capacity setting, while suppressing only the traveling speed low.

### INDUSTRIAL APPLICABILITY

An embodiment of the present invention is applicable as a control device not only for the revolving excavator work machine described above but also for any hydraulic machine that adopts a load-sensing type hydraulic pump control system.

1. A control device for a hydraulic machine including a plurality of hydraulic actuators that are driven by oil ejected from a variable displacement type hydraulic pump driven by an engine,
the control device being configured to, in driving each hydraulic actuator, control a flow rate of oil ejected from the hydraulic pump such that the flow rate satisfies a required flow rate for the hydraulic actuator, and correct a target value for a ratio of a supply flow rate to a required flow rate for each hydraulic actuator, in accordance with a change in an engine rotation number.
the plurality of hydraulic actuators including a hydraulic motor for traveling of the hydraulic machine, the hydraulic motor being configured such that a capacity setting thereof is switchable between at least two different capacity settings; and
the control device being configured to correct the target value for the ratio of the supply flow rate to the required flow rate for each hydraulic actuator, in accordance with not only a change in the engine rotation number but also switching of the capacity of the hydraulic motor.

2. The control device according to claim 1, wherein:
to the plurality of hydraulic actuators, oil ejected from the hydraulic pump is supplied through a meter-in throttle of a direction control valve that is individually provided for each of the hydraulic actuators;
the required flow rate for each actuator is defined by an opening degree of the meter-in throttle of the corresponding direction control valve;
the control device is configured to set a same target value that is common to all the actuators, for a differential pressure between an ejection pressure of oil ejected from the hydraulic pump and a load pressure of oil supplied to each hydraulic actuator, and the control device is further configured to control a flow rate of oil ejected from the hydraulic pump so as to attain the target value for the differential pressure with respect to all the hydraulic actuators; and
by correction of the target value for the differential pressure, correction of the target value for the ratio in accordance with a change in the engine rotation number and conection of the target value for the ratio in accordance with switching of the capacity of the hydraulic motor are implemented.

3. The control device according to claim 2, wherein:
the control device is configured to generate a control pressure for changing the target value for the differential pressure, at a secondary pressure of an electromagnetic proportional valve;
the control device is further configured to store a plurality of maps as a correlation map of a control output value in correlation with the engine rotation number, the control output value being a current value applied to the electromagnetic proportional valve; and
the plurality of maps include two or more maps each corresponding to each of the at least two capacity settings of the hydraulic motor.

4. The control device according to claim 3, wherein:
the two or more maps include a first map corresponding to a small-capacity setting of the hydraulic motor, and a second map corresponding to a large-capacity setting of the hydraulic. motor; and
in the large-capacity setting of the hydraulic motor, only when it is confirmed that the hydraulic motor is actually in a driven state, oil ejected from the hydraulic pump is subjected to a flow rate control based on the second map, and otherwise oil ejected from the hydraulic. pump is subjected to a flow rate control based on the first map.
